(19) United States
(12) Patent Application Publication
(10) Pub. No.: US 2026/0251754 A1
(43) Pub. Date: Aug. 27, 2026

(54) METHOD FOR PROVIDING CALIBRATION DATA FOR ANTENNA DIAGRAMS

(71) Applicant: Robert Bosch GmbH, Stuttgart (DE)

(72) Inventors: Andreas Doerr, Dettingen Unter Teck (DE); Daniel Lopez Cuenca, Stuttgart (DE); Johannes Loehr, Haag (DE); Thomas Anker, Reutlingen (DE); Johannes Meyer, Ettlingen (DE); Juliane Budde, Tuebingen (DE)

(21) Appl. No.: 18/861,698

(22) PCT Filed: Jul. 25, 2023
(86) PCT No.: PCT/EP2023/070530

§ 371 Date: Oct. 30, 2024

(30) Foreign Application Priority Data
Oct. 13, 2022 (DE) 10 2022 210 783.7

(51) Int. Cl. G01S 7/40; G01S 13/931; G06T 11/26

(52) U.S. Cl. CPC G01S 7/40; G01S 13/931; G06T 11/26

(57) ABSTRACT

A method for providing calibration data for calibrating antenna diagrams of devices configured to transmit and/or receive electromagnetic radiation and belong to a common type series. The method includes:
a) selecting a set of devices from the type series for creating a training file; b) for each selected device: measuring a target diagram with a first number of measurement points, and creating an associated source diagram with a second number of measurement points that is less than the first number, and storing the target and source diagrams in the training file; c) using the training file to train a neural network to determine, based on the source diagrams, the respective associated target diagrams; d) measuring the source diagrams of the other devices from the type series ; e) creating the associated target diagrams using the neural network; and f) using these target diagrams as calibration data for the other devices.

### FIELD

The present invention relates to a method for providing calibration data for calibrating antenna diagrams of devices that are configured to transmit and/or receive electromagnetic radiation and that belong to a common type series.

In particular, the present invention relates to the calibration of antenna diagrams of radar sensors used, for example, in motor vehicles for sensing the traffic environment.

### BACKGROUND INFORMATION

A radar sensor with angular resolution for motor vehicles typically comprises a transmitting and receiving antenna with multiple antenna elements arranged at an offset from one another. The angular information of located radar targets is encoded in the amplitude and phase relationships between the signals received by different antenna elements and can be extracted from the received data by aligning the amplitudes and phases of the received signals with an antenna diagram describing the angular dependence of the amplitudes and phases. By aligning with the antenna diagram, the radar cross-section of a located target and thus a measure of the extent of the located object can also be determined.

Ideally, radar sensors that belong to the same type series and are therefore identically constructed should all have the same antenna diagram. However, due to inevitable manufacturing tolerances and other disruptive influences, the actual antenna diagrams of the radar sensors are slightly different from one another. In order to obtain exact location data, it is therefore necessary to compensate for these deviations by calibrating the antenna diagrams individually for each radar sensor. This requires calibration data obtained by measuring the amplitudes and phases of the receive signals under standardized conditions. For this purpose, radar echoes are evaluated by standardized reflectors arranged at known angles relative to the radar sensor. Each position of a reflector represents a measurement point for which an individual measurement must be performed. In order to obtain calibration data indicating the angular dependence of the amplitudes and phases for the corresponding sensor at high angular resolution, the angular distances between the individual measurement points should be as small as possible. However, this means that a relatively large number of measurements must be performed for each individual sensor. The greater the angle range is that is to be covered by the calibration data, the greater is the number of measurements, and this number multiplies for radar sensors with angular resolution in two dimensions (azimuth and elevation). Since the necessary calibration measurements are time-consuming and labor-intensive, accurate calibration of the sensors is costly.

### SUMMARY

An object of the present invention is to minimize the number of required calibration measurements for a given quality of the calibration data.

This object may be achieved according to the present invention by a method. According to an example embodiment of the present invention, the method includes the following steps:
a) selecting a set of devices from the type series for the creation of a training file,
b) for each selected device: measuring a target diagram with a first number of measurement points, and creating an associated source diagram with a second number of measurement points that is less than the first number, and storing the target and source diagrams in the training file,
c) using the training file to train a neural network to determine, on the basis of the source diagrams, the respective associated target diagrams,
d) measuring the source diagrams of the other devices from the type series,
e) creating the associated target diagrams by means of the neural network, and
f) using these target diagrams as calibration data for the other devices.

The aforementioned “devices” may be radar sensors or other systems with which electromagnetic radiation can be transmitted and/or received. The term “target diagrams” is understood to mean antenna diagrams representing the angular dependence of the amplitudes and phases of the received signals at the required angular resolution. The term “source diagrams” is understood to mean antenna diagrams based on a reduced number of measurement points in comparison to the target diagrams.

The present invention is based on the knowledge that sensors (devices) of the same type series have characteristic correlations between different parts of the antenna diagram so that measurement results obtained for measurement points in one part of the diagram can be used to draw conclusions about the appearance of other parts of the diagram, without having to actually measure these other parts of the diagram. According to the present invention, a neural network is trained to recognize these correlations on the basis of suitable training data. Once the neural network has been trained, it is sufficient to measure only the source diagram with a relatively small number of measurement points for an individual sensor and to input these data into the neural network, which then generates the entire target diagram, which can then be used to calibrate the sensor.

In this way, the costs of calibrating the sensors can be considerably reduced.

Advantageous configurations and developments of the present invention are disclosed herein.

According to an example embodiment of the present invention, the source diagrams may be diagrams covering the same angle range as the respective associated target diagrams, but at reduced angular resolution due to the smaller number of measurement points.

On the other hand, the source diagrams may also cover an angle range that is smaller than the angle range of the target diagrams. In this case, the neural network is used to extrapolate the calibration data for the greater angle range.

For sensors with angular resolution in two dimensions, the source diagram may represent a one-dimensional section through the two-dimensional measurement field (e.g., in azimuth), while the target diagram determined by the neural network additionally comprises calibration data for at least one section in the second dimension (in elevation).

For the sensors (devices) selected to create the training file, the entire target diagrams are measured. The associated source diagrams can then be generated simply without additional measurements by reducing the target diagram to a smaller set of measurement points. When training the network, the source diagrams form the input data, and the associated target diagrams provide the feedback, on the basis of which the weights of the neural connections in the network are adjusted, for example by means of back propagation.

In one example embodiment of the present invention, calibration data containing both the source diagram and the target diagram are stored for each sensor, wherein the source diagram is already contained in the target diagram if the source diagram is obtained by reducing the measurement points.

In another example embodiment of the present invention, the measured source diagram is stored in each sensor to be calibrated, but, instead of the target diagram, the sensor stores the trained neural network, which then provides the necessary calibration data during operation of the sensor. This embodiment is advantageous in cases in which the data volume of the parameters of the trained neural network is smaller than the data volume of the entire target diagram.

The present invention also relates to a neural network trained to generate the calibration data according to the method described above, and to a radar sensor in which such a neural network is stored to generate the calibration data.

Exemplary embodiments of the present invention are explained in more detail below with reference to the figures.

### BRIEF DESCRIPTION OF THE DRAWINGS

FIG. 1 shows an example of a measurement field of a radar sensor.

FIG. 2 shows examples of four amplitude antenna diagrams for a section through the measurement field along line II-II in FIG. 1.

FIG. 3 shows examples of amplitude antenna diagrams of the same four radar sensors as in FIG. 2, according to a section through the measurement field along line III-III in FIG. 1.

FIG. 4 shows a measurement field with different section lines.

FIG. 5 shows an example of an amplitude and phase antenna diagram according to a section through the measurement field along line V-V in FIG. 4.

FIG. 6 shows an amplitude and phase antenna diagram according to a section through the measurement field along line VI-VI in FIG. 4.

FIG. 7 shows a diagram for explaining a method according to an exemplary embodiment of the present invention.

FIG. 8 shows a flowchart for a method for training a neural network.

FIG. 9 shows a flowchart for a first exemplary embodiment of the method according to the present invention for providing calibration data.

FIG. 10 shows a flowchart for a method according to a second exemplary embodiment of the present invention.

FIGS. 11 and 12 show diagrams analogous to FIG. 7 for methods according to modified exemplary embodiments of the present invention.

### DETAILED DESCRIPTION OF EXAMPLE EMBODIMENTS

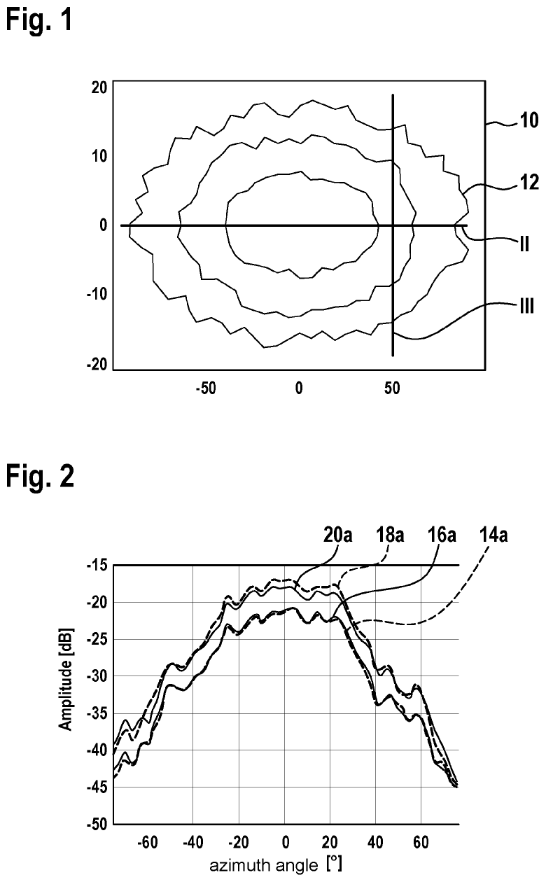

FIG. 1 shows a measurement field 10 of a radar sensor with angular resolution in two dimensions, i.e., both in azimuth (horizontal axis in the diagram) and in elevation (vertical axis). The amplitudes (magnitudes of the complex amplitudes) of the signals received from different directions are represented by contour lines 12.

In a conventional method for providing calibration data for a radar sensor, a horizontal section, for example corresponding to line II in FIG. 1, and a vertical section, for example corresponding to line III in FIG. 1, are placed through the measurement field 10, and the amplitudes of the received signals and the phase differences between the various antenna elements of the radar sensor are measured on each section line with the highest possible angular resolution.

FIG. 2 shows the results of amplitude measurements on line II in FIG. 1 for four identically constructed radar sensors. The four curves 14a, 16a, 18a, and 20a visible in FIG. 2 each indicate the amplitude as a function of the azimuth angle for the four sensors. Each curve is part of an antenna diagram for the corresponding radar sensor. It can be seen that all four curves have a similar profile; however, due to manufacturing tolerances, material properties and the like, there are certain deviations of the curves from one another and from an ideal antenna diagram, which would theoretically be expected for Sensors of this type series.

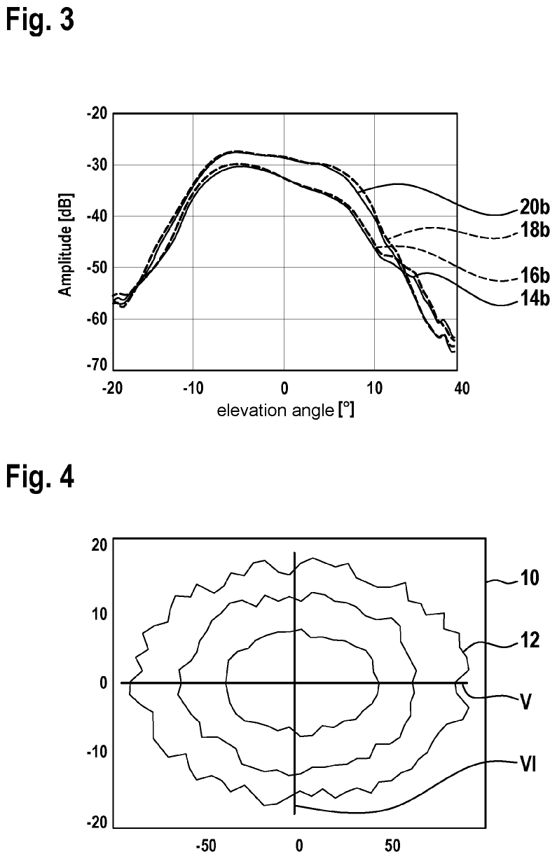

FIG. 3 shows corresponding curves 14b, 16b, 18b and 20b measured along line III in FIG. 1.

The example shown in FIGS. 2 and 3 illustrates a phenomenon that is utilized by the present invention described here. This phenomenon is that sensor-to-sensor deviations in one part of the antenna diagram strongly correlate with deviations in other parts of the antenna diagram. For example, FIG. 2 shows that the curves 14a and 16a have a very similar course and differ only little from one another. This slight deviation between the curves correlates with a likewise only slight deviation between the corresponding curves 14b and 16b in FIG. 3, i.e., in the part of the antenna diagram that corresponds to the section in the direction of elevation. In particular, in this example, the curve 14 b in the elevation angle range of between 12 and 15° has a noticeable anomaly, which is marked by an arrow in FIG. 3. This anomaly is that the curve in this range is flatter than in the adjacent angle ranges. The curve 16b also has the same anomaly.

Observations of this type indicate that sensors that demonstrate very similar behavior in one part of the antenna diagram (here, in the section along line II) also demonstrate similar behavior in other parts of the diagram (here, in the section along line III).

According to the present invention, a neural network is therefore used to recognize such laws or patterns in the antenna diagrams of different sensors and then to predict the form of the antenna diagram on the basis of these laws in ranges in which no measurements have been performed.

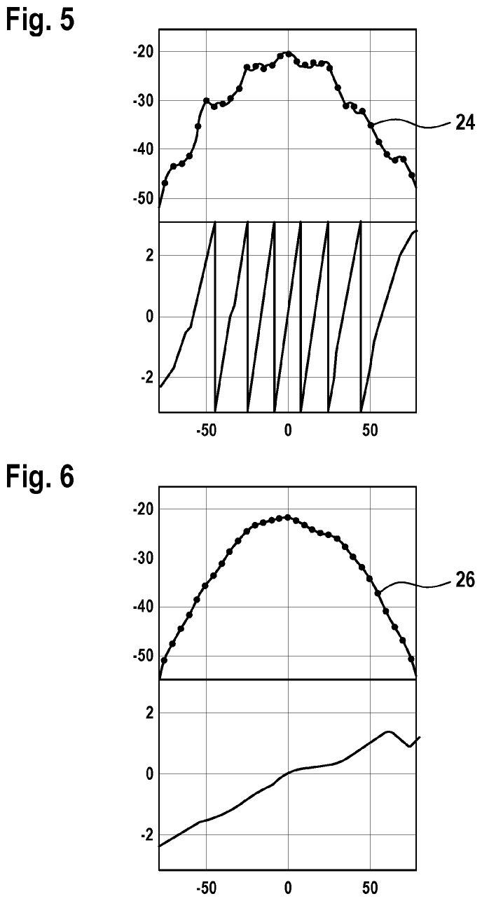

With reference to FIGS. 4 to 6, a conventional method for providing calibration data by measuring antenna diagrams is to be illustrated first. FIG. 4 shows a measurement field 22 of a radar sensor with section lines V, VI, which pass through the center of the measurement field and on which the antenna diagram is to be measured. FIG. 5 shows the amplitude and phase antenna diagram recorded along section line V. To this end, numerous measurements were performed at measurement points 24 distributed on section line V. Each measurement point 24 represents a measurement in which a reflector whose radar echo was measured was positioned on section line V such that its azimuth angle corresponds to the position of the measurement point on the horizontal axis in FIG. 5. The upper part of FIG. 5 shows the amplitude antenna diagram for a single radar sensor, i.e., the measured amplitude (in dB) as a function of the azimuth angle (in °). The lower part of FIG. 5 shows the phase antenna diagram, i.e., the phase difference between adjacent antenna elements as a function of the azimuth angle. This phase difference varies in the range of −p to +p, wherein the values −p and +p are to be equated since they both correspond to a phase angle of 180°. It is understood that the phase differences were in each case measured at the same measurement points 24 as the amplitudes.

FIG. 6 shows the corresponding amplitude and phase antenna diagram recorded on section line IV. Here, the amplitude and phase measurements were also performed at a plurality of measurement points 26 evenly distributed on section line IV.

Even if measuring of the antenna diagram is limited to section lines V and VI, this method requires a large number of individual measurements (corresponding to the sum of the measurement points 24 and 26) to be performed for each sensor.

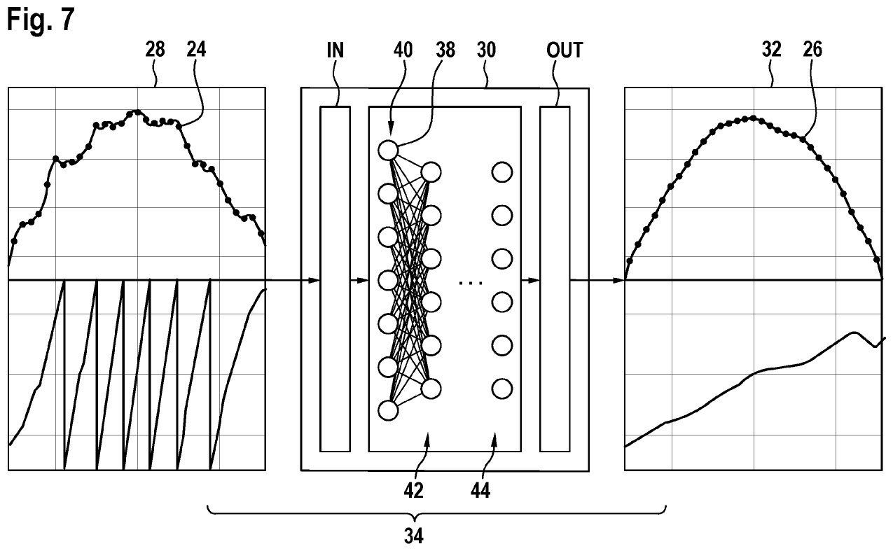

FIG. 7 illustrates a method by means of which the number of required individual measurements can be considerably reduced. In this method, actual measurements for each sensor to be calibrated are performed only at a reduced number of measurement points so that a source diagram 28 representing only a part of the entire antenna diagram is obtained.

In the example shown in FIG. 7, the source diagram 28 is the amplitude and phase antenna diagram for section line V in FIG. 4. The source diagram 28 thus represents only the azimuth section through the measurement field so that no measurements need be performed on elevation section line VI. Accordingly, the number of required individual measurements corresponds to only the number of measurement points 24 on section line V.

A neural network 30 specifically trained for this use case then generates a synthetic diagram 32, which indicates the amplitudes and phase differences on section line VI in FIG. 4 and thus completes the antenna diagram. The source diagram 28 and the synthetic diagram 32 together form a so-called target diagram 34, which provides the calibration data for the calibration of the radar sensor.

The neural network 30 has an input stage IN, which feeds the real parts and imaginary parts of the complex amplitudes for each measurement point 24 of the source diagram 28 into neurons 38 of a first layer 40 of the neural network. In hidden layers 42, the information of the neurons 38 of the first layer 40 is then processed further step by step until a predicted value of the real parts or imaginary parts of the complex amplitude, the predicted value corresponding to a measurement point 26 on section line VI in FIG. 4, is finally obtained in each neuron in an output layer 44. An output stage OUT of the neural network is then used to output the amplitude values and phase values, which together form the synthetic antenna diagram 32.

The neural network 30 may have any conventional architecture for neural networks. In the example shown, at least the lower layers 40, 42 form a fully connected network, in which each neuron of the first layer 40 affects the state of each neuron in the subsequent layer 42. Optionally, the neural network 30 may also be a convolutional neural network as commonly used in pattern recognition algorithms.

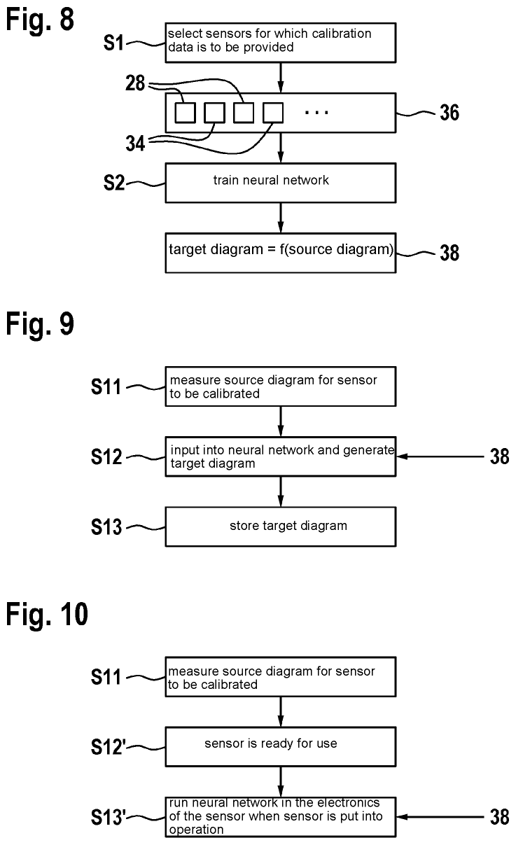

However, before the neural network can perform the function shown in FIG. 7, it must be trained on the basis of appropriate training data. The essential steps of a method for training the network are shown as a flowchart in FIG. 8.

In step S1, a certain number N of sensors is selected from the type series of radar sensors for which the calibration data are to be provided, and a source diagram 28 and a target diagram 34 are measured for each of these sensors in a conventional manner according to the method shown in FIGS. 4 to 6. However, the data for the source diagrams 28 do not have to be measured separately, since the measurement results accrue anyway when the entire target diagram 34 is measured. The totality of the source diagrams 28 and target diagrams 34 obtained in this manner in step S1 for all N sensors forms a training file 36, which provides the training data for the neural network 30.

In step S2, the actual training of the neural network 30 then takes place. Prior to the training, the network 30 is in an initial configuration, in which any neural connection between a neuron 38 of a layer and a neuron of the downstream layer has a certain weight, which determines how much and in what direction the state of the upstream neuron changes the state of the downstream neuron. In a first training step, a first source diagram 28 is then input into the network via the input stage IN. The result obtained from the output stage OUT is compared to the associated target diagram 34 from the training file 36. On the basis of the deviation of the result from the target diagram 34, the weights of the neural connections are changed such that the result is closer to the desired target diagram 34 when the same input is input again. In the next training step, a source diagram 28 for another sensor is then input into the network and the weights are changed again on the basis of the result. If the number N of the pairs of source and target files in the training file 36 is large enough, the weights gradually converge to a configuration in which the network can relatively precisely predict the associated target diagram 34 for each source diagram 28. The totality of the weights then defines a transfer function 38 that assigns the associated target diagram to each source diagram.

What follows in practice is in most cases a validation phase, in which a further number of sensors from the type series is selected in order to test the performance capability of the neural network 30. If the test has a positive result, the network is ready for use so that calibration data (i.e., target files 34) for each sensor of the type series can be generated by means of the method shown in FIG. 7.

FIG. 9 is a flowchart for a possible method for calibrating a sensor. In this method, in a first step S11, a source diagram 28 for the sensor to be calibrated is measured. In step S12, this source file is input into the neural network 30 and the target diagram 34 is generated by means of the neural network or by means of the transfer function 38 defined thereby. In step S13, the target diagram 34, which also contains the original source diagram 28 as a data subset, is then stored. This target diagram 34 then provides the calibration data, with which the sensor is calibrated prior to initial operation.

An alternative method is shown in FIG. 10. In this method, the first step S11 is identical to the step S11 in FIG. 9, i.e., a source diagram for the sensor to be calibrated is measured. In a subsequent step 12′, the source diagram 28 and the neural network 30 are stored in a digital memory of the sensor. The term “storing the neural network” is understood to mean that the connection pattern of the neurons (the connectome) as well as the weights of all neural connections are stored.

After step S12′, the sensor is already ready for use. Only when the sensor is put into operation does the neural network 30 run in the electronics of the sensor in a further step S13′ in order to generate the target diagram 34 and thus the calibration data by means of the transfer function 38. In so doing, the calibration may in each case be limited to those parts of the antenna diagram for which current location data are present.

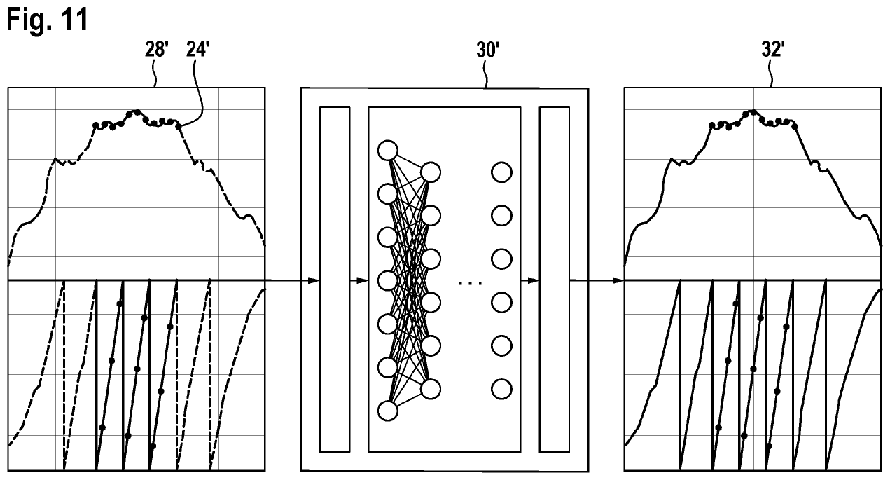

In a diagram analogous to FIG. 7, FIG. 11 illustrates an alternative method for providing calibration data. For the sake of simplicity, it is to be assumed here that the sensor to be calibrated has angular resolution only in azimuth.

A source diagram 28′ in this case comprises only measurement points 24′ that are within a restricted azimuth angle range. The neural network 30 extrapolates the amplitudes and the phase differences to the entire angle range on the basis of the source diagram 28 and thus provides a synthetic diagram 32′, which spans the entire detection angle range of the radar sensor and contains the source diagram 28′ as a data subset. For example, the amplitude curve outside the angle range of the source diagram 28 may be represented by pairs of values for discrete “measurement points” (or better: support points). The number of support points may be greater than the number of measurement points 24′ in the original source diagram 28′. In this case, the neural network 30′ has a greater number of neurons in the output layer than in the first layer.

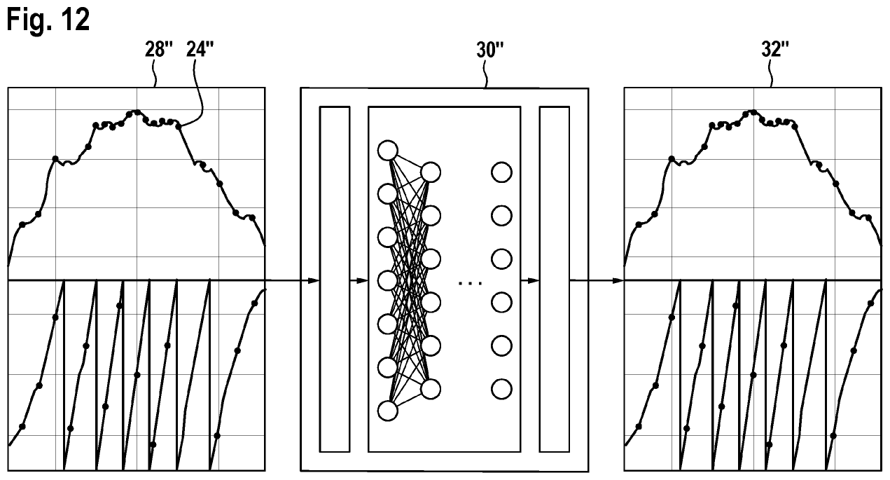

A further method variant is illustrated in FIG. 12.

A source diagram 28″ has measurement points 24″, which are evenly distributed over the entire azimuth angle range. However, the number of these measurement points is relatively low so that the diagram has only a low angular resolution. A neural network 30″ is in this case trained to interpolate intermediate values between the measurement points 24″ so that a synthetic diagram 32″ at higher angular resolution is obtained.

It is understood that the methods shown above in connection with FIGS. 7, 11 and 12 may be combined with one another as needed.

1-10. (canceled)

11. A method for providing calibration data for calibrating antenna diagrams of devices that are configured to transmit and/or receive electromagnetic radiation and that belong to a common type series, the method comprising the following steps:
a) selecting a set of devices from the type series for the creation of a training file;
b) for each selected device:
measuring a respective target diagram with a first number of measurement points, and creating an associated source diagram with a second number of measurement points that is less than the first number, and
storing the target and source diagrams in the training file;
c) using the training file to train a neural network to determine, based on the source diagrams, the respective target diagrams;
d) measuring source diagrams of the other devices from the type series;
e) creating respective target diagrams for the other devices using the neural network; and
f) using the created respective target diagrams as calibration data for the other devices.

12. The method according to claim 11, wherein the neural network is trained to generate a synthetic diagram, which together with the source diagram forms the target diagram.

13. The method according to claim 11, wherein the source diagrams have a smaller range of values than the target diagrams and the neural network is trained to determine the target diagram by extrapolating values from the source diagram.

14. The method according to claim 11, wherein the neural network is trained to interpolate between measurement points of the source diagram when creating the target diagram.

15. The method according to claim 11, wherein, for devices configured for two-dimensional angle measurements, the source diagrams contain only data for one dimension and the neural network is trained to generate data for a second dimension from data of the source diagram.

16. The method according to claim 11, wherein the target diagrams are used to calibrate the devices prior to initial operation.

17. The method according to claim 11, wherein the measured source diagram is stored together with parameters of the neural network in each device and, during operation of the device, is used to provide the calibration data and to calibrate the antenna diagram.

18. A neural network trained to create respective target diagrams for devices that are configured to transmit and/or receive electromagnetic radiation and that belong to a common type series.

19. A radar sensor for motor vehicles, comprising:
a memory for a measured source diagram, and
electronics in which is stored a neural trained to create respective target diagrams for devices that are configured to transmit and/or receive electromagnetic radiation and that belong to a common type series.
